(19) United States
(12) Patent Application Publication
(10) Pub. No.: US 2008/0006056 A1
(43) Pub. Date: Jan. 10, 2008

(54) PROCESS FOR PRODUCING SYNTHETIC QUARTZ AND SYNTHETIC QUARTZ GLASS FOR OPTICAL MEMBER

(75) Inventor: Keigo HINO, Koriyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/853,891

(22) Filed: Sep. 12, 2007

Related U.S. Application Data
(63) Continuation of application No. PCT/JP2006/306388, filed on Mar. 22, 2006.

(30) Foreign Application Priority Data
Mar. 29, 2005 (JP) 2005-095655

(51) Int. Cl. C03B 19/06; C03C 3/06

(52) U.S. Cl. 65/17.4; 501/54

(57) ABSTRACT

The present invention provides a process for producing a synthetic quartz glass, comprising: (a) depositing fine quartz glass particles synthesized by flame hydrolysis of a glass-forming material on a target to form a porous quartz glass base; (b) presintering the porous quartz glass base; (c) heating the presintered porous quartz glass base to a temperature not lower than the vitrification temperature to obtain a transparent synthetic quartz glass body; and (d) gradually cooling the synthetic quartz glass body under vacuum. The invention also provides a synthetic quartz glass for an optical member produced by the process. According to the invention, a synthetic quartz glass having reduced birefringence can be obtained.

### TECHNICAL FIELD

The present invention relates to a process for producing a synthetic quartz glass and a synthetic quartz glass for an optical member. More particularly, the invention relates to a process for producing a synthetic quartz glass suitable for an optical member, such as, e.g., a lens or photomask substrate, for a lithographic exposure tool having an exposure light wavelength of 200 nm or shorter, and also relates to the synthetic quartz glass for an optical member.

### BACKGROUND ART

In the production of semiconductor integrated circuits, lithographic exposure tools for reductively projecting and transferring a fine circuit pattern drawn in a photomask onto a wafer are extensively used. With the trend toward higher degrees of integration and higher functions in circuits, the circuits are becoming finer and the lithographic exposure tools have come to be required to form a high-resolution circuit pattern image on a wafer surface while attaining a great focal depth. The wavelengths of exposure light sources are becoming shorter. KrF excimer lasers (wavelength, 248 nm) and ArF excimer lasers (wavelength, 193 nm) are being used as exposure light sources in place of the g-line (wavelength, 436 nm) and i-line (wavelength, 365 nm) heretofore in use. Furthermore, F₂ lasers (wavelength, 157 nm) are being put to practical use.

Optical members, such as lenses and photomask substrates, which have been mainly used for lithographic exposure tools having an exposure light wavelength of 200 nm or shorter are ones made of a synthetic quartz glass, because synthetic quartz glasses have advantages, for example, that they have excellent transparency to light in a wide range of from the near infrared region to the ultraviolet region, have an extremely low coefficient of thermal expansion, and can be processed relatively easily. For example, photomask substrates for, e.g., ArF excimer lasers are required to have a surface flatness of about 0.5 μm and a parallelism of about 5 μm besides resistance to ArF excimer laser light.

Known as a process for producing the synthetic quartz glass is a process which comprises: forming a porous quartz glass base of a nearly cylindrical shape by the so-called VAD (vapor-phase axial deposition) method in which a silicon compound, e.g., silicon tetrachloride, is introduced into an oxyhydrogen flame to synthesize fine quartz glass particles by flame hydrolysis and the fine quartz glass particles are deposited on a rotating target; and heating this base to a temperature not lower than the vitrification temperature to convert it into a transparent glass and thereby obtain a synthetic quartz glass body (see, for example, patent document 1).

Patent Document 1: JP-A-62-72536

Recently, immersion exposure, in which exposure with a lithographic exposure tool is conducted while filling the space between the projection lens of the lithographic exposure tool and the wafer with a liquid, and polarized illumination, in which those components of polarized light which exert an adverse influence on resolution are diminished to thereby heighten image-forming contrast and improve resolution, are being conducted in order to attain a further higher resolution with a lithographic exposure tool. The optical members for use in such immersion exposure technique and polarized illumination technique are required to have low birefringence so as not to disorder the polarization of the exposure light which passes therethrough. However, there are cases where the synthetic quartz glass body obtained through conversion to a transparent glass has a residual strain which is causative of birefringence.

A technique generally employed for removing the strain remaining in a glass is to gradually cool the glass in an inert gas atmosphere or in the atmosphere. However, because synthetic quartz glasses have a higher melting temperature than the optical glasses heretofore in use, it has been difficult to sufficiently remove the strain from a synthetic quartz glass even when the synthetic quartz glass is gradually cooled under the conditions employed in the gradual cooling of the optical glasses heretofore in use.

### DISCLOSURE OF THE INVENTION

The invention has been achieved in view of the circumstances described above.

An object of the invention is to provide a process for synthetic quartz glass production intended to attain a reduction in birefringence.

Another object is to provide a synthetic quartz glass for an optical member produced by the process.

For accomplishing the objects, the process for producing a synthetic quartz glass of the invention comprises:

(a) depositing fine quartz glass particles synthesized by flame hydrolysis of a glass-forming material on a target to form a porous quartz glass base;

(b) presintering the porous quartz glass base;

(c) heating the presintered porous quartz glass base to a temperature not lower than the vitrification temperature to obtain a transparent synthetic quartz glass body; and

(d) gradually cooling the synthetic quartz glass body under vacuum.

In the process for synthetic quartz glass production described above, the synthetic quartz glass body obtained through conversion to a transparent glass is gradually cooled under vacuum. By this operation, the strain remaining in the synthetic quartz glass body can be sufficiently removed and, hence, the birefringence of the synthetic quartz glass body can be reduced.

Although the reasons why the strain remaining in the synthetic quartz glass body is sufficiently removed by the gradual cooling of the synthetic quartz glass under vacuum have not been entirely elucidated, the following factor can be presumably considered. Namely, when the gradual cooling of the synthetic quartz glass body is conducted under vacuum, heat dissipation from the synthetic quartz glass body can be allowed to proceed mainly by radiation while inhibiting heat dissipation by convection. Compared to heat dissipation by convection, heat dissipation by radiation enables the synthetic quartz glass body to uniformly cool throughout. It is thought that the strain remaining in the synthetic quartz glass body can be thus removed sufficiently to thereby reduce the birefringence of the synthetic quartz glass body.

Preferably, the degree of vacuum in the step of gradually cooling the synthetic quartz glass body under vacuum is 10 Pa or lower, more preferably 5 Pa or lower, in terms of pressure. That is, the gradual cooling step is preferably carried out in an atmosphere having a pressure of 10 Pa or lower, more preferably 5 Pa or lower.

Furthermore, in the step of gradually cooling the synthetic quartz glass body under vacuum, the synthetic quartz glass body is preferably held at a maximum temperature for 5 hours or longer, the maximum temperature being 1,150° C. or higher. The maximum temperature is preferably 1,300° C. or lower, more preferably 1,250° C. or lower.

Moreover, in the step of gradually cooling the synthetic quartz glass body under vacuum, the synthetic quartz glass body is cooled preferably at a cooling rate of 10° C./hr or lower in the temperature range of from the maximum temperature to 500° C.

More preferably, in the step of gradually cooling the synthetic quartz glass body under vacuum, the synthetic quartz glass body is cooled at a cooling rate of 2° C./hr or lower at least in the temperature range of from 1,150° C. to 1,000° C.

According to the process for producing a synthetic quartz glass of the invention, a synthetic quartz glass body having reduced birefringence can be obtained and a synthetic quartz glass for an optical member can be produced which has excellent optical properties and is suitable for an optical member for a lithographic exposure tool having an exposure light wavelength of 200 nm or shorter.

### BRIEF DESCRIPTION OF THE DRAWINGS

FIG. 1(a) is a graph showing a birefringence distribution before gradual cooling of the synthetic quartz glass body of an Example, and FIG. 1(b) is a graph showing a birefringence distribution after gradual cooling of the synthetic quartz glass body.

FIG. 2(a) is a graph showing a birefringence distribution before gradual cooling of the synthetic quartz glass body of an Example, and FIG. 2(b) is a graph showing a birefringence distribution after gradual cooling of the synthetic quartz glass body.

FIG. 3(a) is a graph showing a birefringence distribution before gradual cooling of the synthetic quartz glass body of an Example, and FIG. 3(b) is a graph showing a birefringence distribution after gradual cooling of the synthetic quartz glass body.

FIG. 4(a) is a graph showing a birefringence distribution before gradual cooling of the synthetic quartz glass body of an Example, and FIG. 4(b) is a graph showing a birefringence distribution after gradual cooling of the synthetic quartz glass body.

FIG. 5(a) is a graph showing a birefringence distribution before gradual cooling of the synthetic quartz glass body of a Comparative Example, and FIG. 5(b) is a graph showing a birefringence distribution after gradual cooling of the synthetic quartz glass body.

FIG. 6(a) is a graph showing a birefringence distribution before gradual cooling of the synthetic quartz glass body of a Comparative Example, and FIG. 6(b) is a graph showing a birefringence distribution after gradual cooling of the synthetic quartz glass body.

FIG. 7(a) is a graph showing a birefringence distribution before gradual cooling of the synthetic quartz glass body of a Comparative Example, and FIG. 7(b) is a graph showing a birefringence distribution after gradual cooling of the synthetic quartz glass body.

### BEST MODE FOR CARRYING OUT THE INVENTION

One embodiment of the process for synthetic quartz glass production according to the invention is explained below in detail.

In this embodiment, a glass-forming material is first subjected to flame hydrolysis to synthesize fine quartz glass particles and the fine quartz glass particles are deposited on a target to form a porous quartz glass base.

The glass-forming material is not particularly limited as long as it can be gasified. However, silicon halide compounds such as chlorides, e.g., SiCl₄, SiHCl₃, SiH₂Cl₂, and Si(CH₃)Cl₃, fluorides, e.g., SiF₄, SiHF₃, and SiH₂F₂, bromides, e.g., SiBr₄ and SiHBr₃, and iodides, e.g., SiI₄, are preferred from the standpoints of workability and cost.

The porous quartz glass base is formed by introducing any of those glass-forming materials into an oxyhydrogen flame to hydrolyze it and depositing on a target the fine quartz glass particles thus synthesized. It is preferred that this target on which the fine quartz glass particles are to be deposited should be rotated from the standpoint of regulating the shape of the bulk density distribution curve of the porous quartz glass to be obtained. The rotation speed of the target is typically in the range of 0.1 to 10 rpm although it varies depending on the rate of deposition of the fine quartz glass particles.

The porous quartz glass base obtained is relatively brittle. This porous quartz glass base is hence presintered. This presintering may be accomplished by heating the base in the atmosphere at 1,300 to 1,360° C. for 3 to 7 hours. The presintering may be conducted in an inert atmosphere such as nitrogen or argon.

Subsequently, the porous quartz glass base presintered is heated to a temperature not lower than the vitrification temperature to convert the base into a transparent glass. Thus, a synthetic quartz glass body is obtained. This conversion to a transparent glass is typically accomplished by heating the porous quartz glass base at 1,400 to 1,550° C. for 1 hour or longer.

Next, the synthetic quartz glass body obtained by the conversion to a transparent glass is gradually cooled under vacuum. The degree of vacuum in this gradual cooling step is preferably 10 Pa or lower, especially preferably 1 Pa or lower, in terms of pressure. By regulating the degree of vacuum to 10 Pa or lower in terms of pressure, the strain remaining in the synthetic quartz glass body can be sufficiently removed to thereby reduce the birefringence of the synthetic quartz glass body.

In the gradual cooling step, it is preferred that the synthetic quartz glass body be held for 5 hours or longer at a maximum temperature which is 1,150° C. or higher.

The rate of cooling the synthetic quartz glass body in the temperature range of from the maximum temperature to 500° C. is preferably 10° C./hr or lower, more preferably 8° C./hr or lower, especially preferably 5° C./hr or lower.

Furthermore, since the annealing point of the synthetic quartz glass is about 1,100° C., the rate of cooling the synthetic quartz glass body at least in the temperature range of from 1,150° C. to 1,000° C. is preferably 2° C./hr or lower, more preferably 1° C./hr or lower, especially preferably 0.5° C./hr or lower.

For the gradual cooling step may be used a conventional vacuum furnace in which the heater, shield, etc. are constituted of alumina, silica, or the like. However, it is preferred to use a vacuum carbon furnace in which the heater, shield, etc. are constituted of carbon for the purpose of preventing impurities (e.g., particles of alumina, silica, etc.) from coming into the synthetic quartz glass body.

The synthetic quartz glass body obtained through the steps described above can have a birefringence, as measured at a wavelength of 633 nm, of 0.3 nm/cm or lower on the average. In particular, the birefringence thereof as measured at a wavelength of 633 nm can be reduced to 0.1 nm/cm or lower on the average by optimizing the rate of cooling the synthetic quartz glass body during the gradual cooling step in such a highly vacuum state that the degree of vacuum is, for example, 1 Pa or lower in terms of pressure.

There are cases where in the process for synthetic quartz glass production described above, a step in which the synthetic quartz glass body obtained by the conversion to a transparent glass is heated to a temperature not lower than the softening point and molded into a desired shape is conducted before the synthetic quartz glass body is gradually cooled under vacuum. The range of temperatures in this molding is preferably from 1,650° C. to 1,800° C. At temperatures lower than 1,650° C., the synthetic quartz glass body undergoes substantially no self-weight deformation because it has a high viscosity. In addition, there is a possibility that cristobalite, which is a crystal phase of SiO₂, might grow to cause the so-called devitrification. At temperatures higher than 1,800° C., there is a possibility that SiO₂ sublimation might become not negligible. Although the direction in which the synthetic quartz glass body is caused to undergo self-weight deformation is not particularly limited, it is preferably the same as the growth direction of the porous quartz glass base.

### EXAMPLES

The present invention will be illustrated in greater detail with reference to the following Examples, but the invention should not be construed as being limited thereto.

First, a porous quartz glass base is formed by introducing SiCl₄ into an oxyhydrogen flame to hydrolyze it and synthesize fine synthetic quartz glass particles and depositing the particles on a target. The target on which the fine quartz glass particles are deposited is rotated at a rotation speed of 5 rpm.

The porous quartz glass base obtained is relatively brittle. This porous quartz glass base is hence presintered in the atmosphere at a temperature of 1,320° C. for 5.5 hours.

Subsequently, the porous quartz glass base presintered is heated at 1,435° C. for 2 hours to convert it into a transparent glass and thereby obtain a synthetic quartz glass body.

The synthetic quartz glass body obtained is placed in a carbon mold and heated to a temperature of 1,750° C. or higher in an inert gas atmosphere to mold the object into a cylindrical shape of about 400 mm in diameter. Thereafter, the glass molded is gradually cooled. The rates of heating/cooling in respective temperature ranges in the gradual cooling step are shown below.

| | | |
|---|---|---|
| Room temperature → 1,250° C. | 6.5 | hours |
| 1,250° C. (holding) | 24 | hours |
| 1,250° C. → 1,150° C. | 50 | hours (−2° C./hr) |
| 1,150° C. → 1,080° C. | 140 | hours (−0.5° C./hr) |
| 1,080° C. → 1,040° C. | 160 | hours (−0.25° C./hr) |
| 1,040° C. → 1,000° C. | 80 | hours (−0.5° C./hr) |
| 1,000° C. → 500° C. | 145 | hours |

After the gradual cooling to 500° C., the heater is switched off to allow the glass to cool naturally. The gradual cooling step was conducted under vacuum to prepare synthetic quartz glass bodies of Examples 1 to 4 as examples according to the invention. Separately, the gradual cooling step was conducted in the atmosphere to prepare synthetic quartz glass bodies of Examples 5 to 7 as comparative examples.

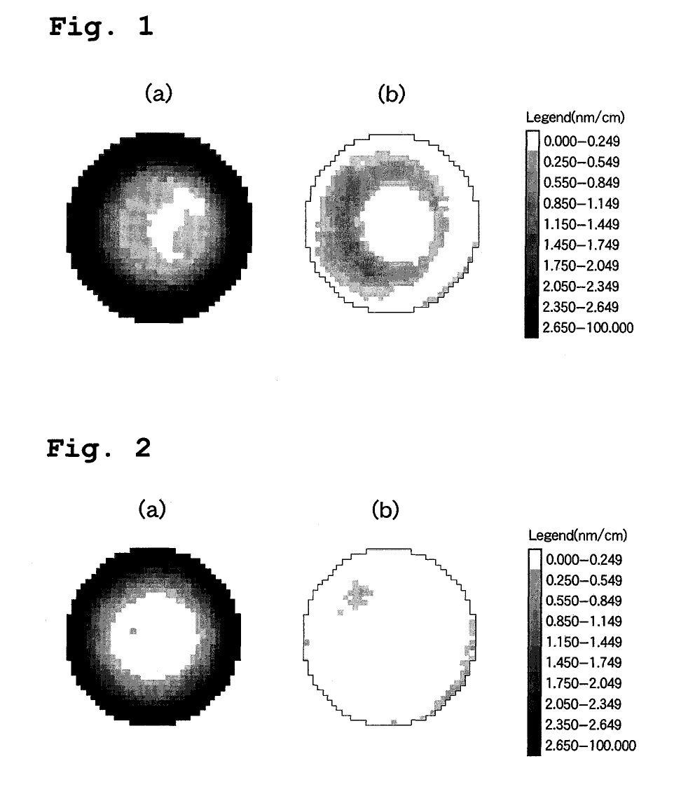

The synthetic quartz glass bodies of Examples 1 to 7 which had not undergone the gradual cooling and those which had undergone the gradual cooling were examined for birefringence in the following manner. In each glass body, a section thereof perpendicular to the axial direction was examined with EXICOR 350AT, manufactured by HINDS Inc., which employed an He—Ne laser (wavelength, 633 nm) as a light source. This birefringence measurement was made on each of points selected in a central area within a diameter range of 340 mm in the section which were distributed in a lattice pattern at an interval of 10 mm. The results of the measurements are shown in FIGS. 1 to 7.

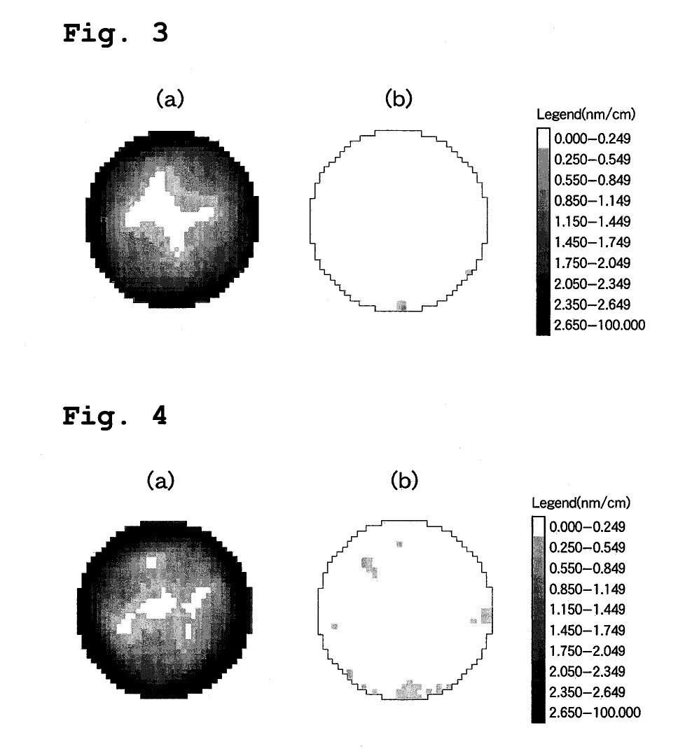

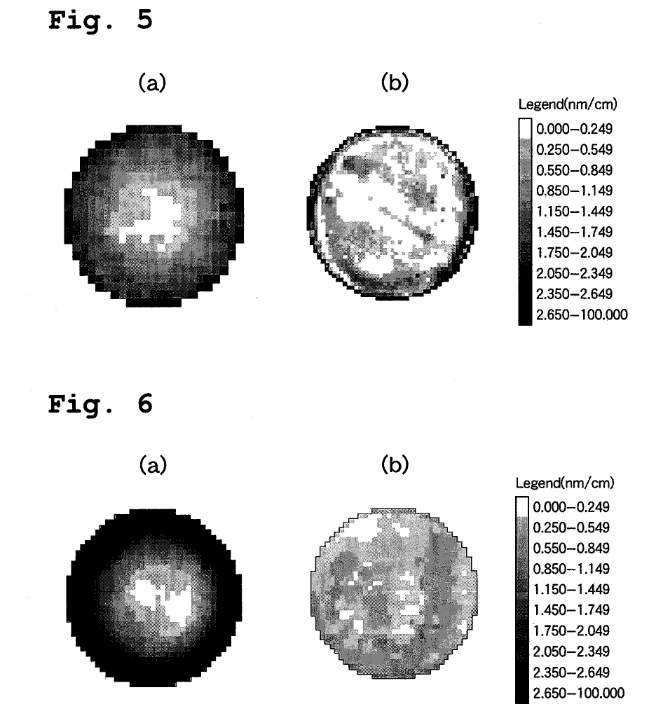

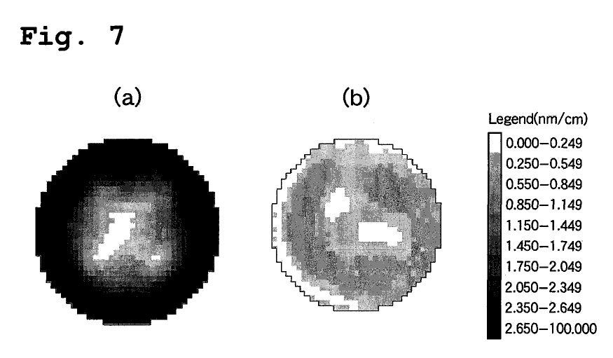

FIG. 1(a) is a graph showing a birefringence distribution before gradual cooling of the synthetic quartz glass body of Example 1, and FIG. 1(b) is a graph showing a birefringence distribution after gradual cooling of the synthetic quartz glass body of Example 1. Likewise, FIG. 2(a) and FIG. 2(b) are graphs showing birefringence distributions before and after gradual cooling, respectively, of the synthetic quartz glass body of Example 2. FIG. 3(a) and FIG. 3(b) are graphs showing birefringence distributions before and after gradual cooling, respectively, of the synthetic quartz glass body of Example 3. FIG. 4(a) and FIG. 4(b) are graphs showing birefringence distributions before and after gradual cooling, respectively, of the synthetic quartz glass body of Example 4. FIG. 5(a) and FIG. 5(b) are graphs showing birefringence distributions before and after gradual cooling, respectively, of the synthetic quartz glass body of Example 5. FIG. 6(a) and FIG. 6(b) are graphs showing birefringence distributions before and after gradual cooling, respectively, of the synthetic quartz glass body of Example 6. FIG. 7(a) and FIG. 7(b) are graphs showing birefringence distributions before and after gradual cooling, respectively, of the synthetic quartz glass body of Example 7.

As shown in FIGS. 1 to 7, the birefringence before gradual cooling of each of the synthetic quartz glass bodies of Examples 1 to 4, which are examples according to the invention, and Examples 5 to 7, which are comparative examples, increases from the center toward the periphery. In the synthetic quartz glass bodies of Examples 5 to 7, which are comparative examples, relatively high birefringence values are observed everywhere even after gradual cooling. In contrast, in the synthetic quartz glass bodies of Examples 1 to 4, which are examples according to the invention, the birefringence thereof after gradual cooling has been reduced throughout.

The results of the examination of the synthetic quartz glass bodies of Examples 1 to 7 which had undergone gradual cooling are shown in Table 1.

TABLE 1

| | Ex. 1 | Ex. 2 | Ex. 3 | Ex. 4 | Ex. 5 | Ex. 6 | Ex. 7 |
|---|---|---|---|---|---|---|---|
| Max. (nm/cm) | 0.44 | 0.40 | 0.36 | 0.54 | 12.34 | 1.28 | 0.88 |
| Min. (nm/cm) | 0.01 | 0.01 | 0.01 | 0.01 | 0.00 | 0.01 | 0.02 |
| Ave. (nm/cm) | 0.23 | 0.16 | 0.08 | 0.16 | 0.49 | 0.53 | 0.47 |

As Table 1 shows, the synthetic quartz glass bodies of Examples 1 to 4, which are examples according to the invention, attained average birefringences of 0.3 nm/cm or lower, with the maximum birefringence value being 0.54 nm/cm (Example 4). In contrast, the synthetic quartz glass bodies of Examples 5 to 7, which are comparative examples, had average birefringences of about 0.5 nm/cm, with the maximum birefringence value being 12.34 nm/cm (Example 5).

It was thus demonstrated that the gradual cooling under vacuum of the synthetic quartz glass body obtained through conversion to a transparent glass is more effective in reducing the birefringence of the synthetic quartz glass body than the gradual cooling in the atmosphere which has been employed hitherto.

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-095655 filed Mar. 29, 2006, the contents thereof being herein incorporated by reference.

### INDUSTRIAL APPLICABILITY

According to the process for producing a synthetic quartz glass of the invention, a synthetic quartz glass body having reduced birefringence can be obtained and a synthetic quartz glass for an optical member can be produced which has excellent optical properties and is suitable for an optical member for a lithographic exposure tool having an exposure light wavelength of 200 nm or shorter.

1. A process for producing a synthetic quartz glass, comprising:
(a) depositing fine quartz glass particles synthesized by flame hydrolysis of a glass-forming material on a target to form a porous quartz glass base;
(b) presintering the porous quartz glass base;
(c) heating the presintered porous quartz glass base to a temperature not lower than the vitrification temperature to obtain a transparent synthetic quartz glass body; and
(d) gradually cooling the synthetic quartz glass body under vacuum.

2. The process for producing a synthetic quartz glass of claim 1, wherein the gradual cooling step is carried out at a degree of vacuum of 10 Pa or lower in terms of pressure.

3. The process for producing a synthetic quartz glass of claim 1, wherein the gradual cooling step comprises holding the synthetic quartz glass body at a maximum temperature for 5 hours or longer, the maximum temperature being 1,150° C. or higher.

4. The process for producing a synthetic quartz glass of claim 3, wherein the gradual cooling step comprises cooling the synthetic quartz glass body at a cooling rate of 10° C./hr or lower in the temperature range of from the maximum temperature to 500° C.

5. The process for producing a synthetic quartz glass of claim 4, wherein the cooling rate at least in the temperature range of from 1,150° C. to 1,000° C. in the gradual cooling step is 2° C./hr or lower.

6. A synthetic quartz glass for an optical member produced by the process of claim 1.
